(19) United States
(12) Patent Application Publication
(10) Pub. No.: US 2025/0125504 A1
(43) Pub. Date: Apr. 17, 2025

(54) MULTI-TAB BATTERY AND ELECTRONIC DEVICE

(71) Applicant: EVE ENERGY CO., LTD., Huizhou (CN)

(72) Inventors: Xiaobo DENG, Huizhou (CN); Xianyu LIANG, Huizhou (CN)

(73) Assignee: EVE ENERGY CO., LTD., Huizhou (CN)

(21) Appl. No.: 18/914,171

(22) Filed: Oct. 13, 2024

(30) Foreign Application Priority Data
Oct. 13, 2023 (CN) 202322762419.8
Jul. 31, 2024 (WO) PCT/CN2024/108991

(51) Int. Cl. H01M 50/538; H01M 10/04; H01M 50/103; H01M 50/15

(52) U.S. Cl. CPC H01M 50/538; H01M 10/0431; H01M 50/103; H01M 50/15

(57) ABSTRACT

A multi-tab battery and an electronic device are provided. The multi-tab battery includes a housing and a battery cell. The battery cell is arranged in the housing. The battery cell includes a separator, a positive electrode sheet, a negative electrode sheet, a plurality of positive electrode tabs and a plurality of negative electrode tabs. The plurality of positive electrode tabs are arranged at intervals along a first direction and protrude from the positive electrode sheet by a first length in an extension direction of the battery cell, and the plurality of negative electrode tabs are arranged at intervals along a second direction and protrude from the negative electrode sheet by a second length in the extension direction of the battery cell.

### CROSS-REFERENCE TO RELATED APPLICATION

This application claims priority to and the benefit of Chinese Patent Application No. 202322762419.8, filed on Oct. 13, 2023, and PCT Application No. PCT/CN2024/108991, filed on Jul. 31, 2024, the disclosures of which are incorporated herein by reference in their entireties.

### TECHNICAL FIELD

The present application relates to the technical field of battery, and in particular to a multi-tab battery and an electronic device.

### BACKGROUND

In the related technology, the positive electrode tab of a cylindrical battery has a single-tab structure, and the negative electrode tab of the cylindrical battery has a double-tab structure. This type of cylindrical battery can provide power for vehicles, mobile phones, portable devices, laptops, ships, spacecraft, electric toys and electric tools, etc.

However, batteries with a single-tab structure or a single-tab structure for the positive electrode and a double-tab structure for the negative electrode have defects such as large impedance, limited current capacity, and uneven temperature difference distribution, and cannot be used in ultra-high rate equipment.

### SUMMARY

In a first aspect, the present application provides a multi-tab battery, including:
a housing; and
a battery cell, arranged in the housing;
wherein the battery cell includes a separator, a positive electrode sheet, a negative electrode sheet, a plurality of positive electrode tabs and a plurality of negative electrode tabs;
wherein the separator is located between the positive electrode sheet and the negative electrode sheet; the plurality of positive electrode tabs are connected to the positive electrode sheet and are located at one end of the positive electrode sheet; the plurality of negative electrode tabs are connected to the negative electrode sheet and are located at one end of the negative electrode sheet; the battery cell is formed by winding the separator, the positive electrode sheet and the negative electrode sheet;
wherein the plurality of the positive electrode tabs are arranged at intervals along a first direction and protrude from the positive electrode sheet by a first length in an extension direction of the battery cell; the plurality of the negative electrode tabs are arranged at intervals along a second direction and protrude from the negative electrode sheet by a second length in the extension direction of the battery cell; the first direction intersects or overlaps with the second direction, and the first length is greater than or same as the second length.

In a second aspect, the present application also provides an electronic device including a multi-tab battery.

The multi-tab battery and the electronic device according to the present application includes at least the following beneficial effects.

A plurality of positive electrode tabs are provided at one end of the positive electrode sheet, and a plurality of negative electrode tabs are provided at the one end of the negative electrode sheet. The plurality of positive electrode tabs and the plurality of negative electrode tabs are arranged at unequal intervals so that orthographic projections thereof on the inner wall of the housing overlap after the battery cell is windingly formed. This is beneficial to reducing the battery impedance, reducing the temperature rise and internal temperature gradient during the high-rate discharge process of the battery, and achieving a short electron transmission path, and the temperature and current density distribution during the charging and discharging process are more uniform, which is beneficial to improving the thermal safety and service life of the battery.

### BRIEF DESCRIPTION OF THE DRAWINGS

FIG. 1 is a schematic diagram of the structure of a multi-tab battery according to an embodiment of the present application.

FIG. 2 is a schematic diagram of the structure of the positive electrode sheet and the negative electrode sheet according to an embodiment of the present application.

FIG. 3 is a schematic diagram of the structure of a battery cell according to an embodiment of the present application.

FIG. 4 is an exploded schematic diagram of a battery cell according to an embodiment of the present application.

FIG. 5 is a further schematic diagram of the structure of a multi-tab battery according to an embodiment of the present application.

FIG. 6 is a schematic diagram of the structure of the cover according to an embodiment of the present application.

### REFERENCE NUMERALS

10, housing; 11, cover; 12, housing body; 111, insulator; 112, conductor; 20, battery cell; 20A, first end; 20B, second end; 21, positive electrode sheet; 211, positive electrode tab; 22, negative electrode sheet; 221, negative electrode tab; 23, separator.

### DETAILED DESCRIPTION

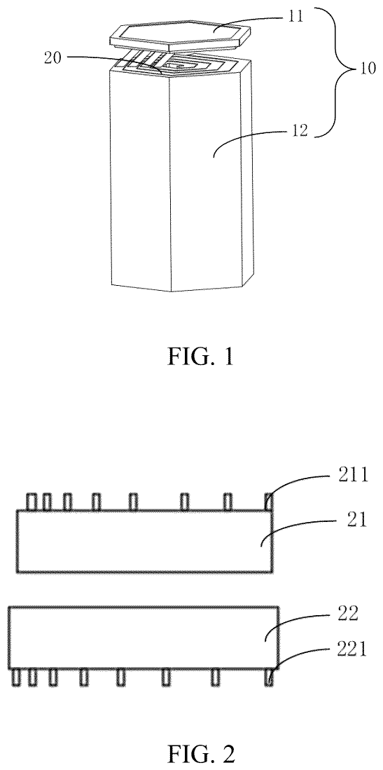

FIG. 1 is a schematic diagram of the structure of a multi-tab battery according to an embodiment of the present application. FIG. 2 is a schematic diagram of the structure of the positive electrode sheet and the negative electrode sheet according to an embodiment of the present application.

Please refer to FIGS. 1 and 2, embodiments of the present application provide a multi-tab battery, including a housing 10 and a battery cell 20. The battery cell 20 is arranged in the housing 10.

Please refer to FIG. 4, the battery cell 20 includes a separator 23, a positive electrode sheet 21, a negative electrode sheet 22, a plurality of positive electrode tabs 211 and a plurality of negative electrode tabs 221. The separator 23 is located between the positive electrode sheet 21 and the negative electrode sheet 22. The plurality of positive electrode tabs 211 are connected to the positive electrode sheet 21 and are located at one end of the positive electrode sheet 21. The plurality of negative electrode tabs 221 are connected to the negative electrode sheet 22 and are located at one end of the negative electrode sheet 22. The battery cell 20 is formed by winding the separator 23, the positive electrode sheet 21 and the negative electrode sheet 22. The plurality of positive electrode tabs 211 are arranged at intervals along the first direction Z1 and protrude from the positive electrode sheet 21 by a first length in the extension direction of the battery cell 20. The plurality of negative electrode tabs 221 are arranged at intervals along the second direction Z2 and protrude from the negative electrode sheet 22 by a second length in the extension direction of the battery cell 20. The first direction Z1 intersects or coincides with the second direction Z2, and the first length is greater than or same as the second length. The multi-tab battery according to this embodiment is conducive to reducing battery impedance, reducing the temperature rise and internal temperature gradient of the battery during high-rate discharge. The electron transmission path of the battery is short, and the temperature and current density distribution during the charging and discharging process are more uniform, which is conducive to improving the thermal safety and service life of the battery.

In some embodiments of the present application, the first length ranges from 15 mm to 17 mm, and the second length ranges from 13 mm to 15 mm.

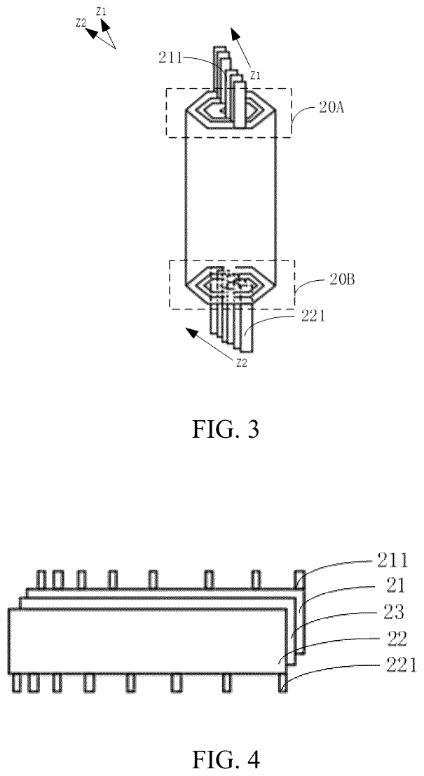

FIG. 3 is a schematic diagram of the structure of a battery cell according to an embodiment of the present application.

Referring to FIG. 3, a plurality of positive electrode tabs 211 are disposed on one end face of the positive electrode sheet 21, and a plurality of negative electrode tabs 221 are disposed on one end face of the negative electrode sheet 22. The positive electrode sheet 21 and the negative electrode sheet 22 are overlapped and wound, so that the plurality of positive electrode tabs 211 and the plurality of negative electrode tabs 221 can be respectively located at the two ends of the battery cell 20, forming positive and negative electrodes to be disposed in the housing 10.

The plurality of positive electrode tabs 211 are arranged at unequal intervals on one end face of the positive electrode sheet 21, and the plurality of negative electrode tabs 221 are arranged at unequal intervals on one end face of the negative electrode sheet 22. The distance between two adjacent positive electrode tabs 211 is the length of one circle of the positive electrode sheet 21, and the distance between two adjacent negative electrode tabs 221 is the length of one circle of the negative electrode sheet 22. It can be understood that the distance between the plurality of positive electrode tabs 211 arranged at one end face of the positive electrode sheet 21 gradually increases with the number of layers that the battery cell winds to form, so that, on the inner wall of the housing 10, the orthographic projections of the plurality of positive electrode tabs 211 arranged on the wound battery cell 20 can overlap; and the distance between the plurality of negative electrode tabs 221 arranged at one end face of the negative electrode sheet 22 gradually increases with the number of layers that the battery cell winds to form, so that, on the inner wall of the housing 10, the orthographic projections of the plurality of negative electrode tabs 221 arranged on the wound battery cell 20 can overlap.

The widths of the plurality of positive electrode tabs 211 may be the same, and the widths of the plurality of negative electrode tabs 221 may be the same. The widths of the plurality of positive electrode tabs 211 may alternatively be different, and the widths of the plurality of negative electrode tabs 221 may alternatively be different, as long as the function of the multi-tab battery of the present application is not affected. Therefore, the widths of the plurality of positive electrode tabs 211 and the plurality of negative electrode tabs 221 are not limited.

FIG. 2 is a schematic diagram of the structure of the positive electrode sheet and the negative electrode sheet according to an embodiment of the present application.

Please refer to FIG. 2. the coincidence of the first direction Z1 and the second direction Z2 can be understood as: the projections of the plurality of positive electrode tabs 211 on the end face of the negative electrode of the wound battery cell 20 overlap with the projections of the plurality of negative electrode tabs 221; the intersection of the first direction Z1 and the second direction Z2 can be understood as: the projections of the plurality of positive electrode tabs 211 on the end face of the negative electrode of the wound battery cell 20 do not overlap but intersect with the projections of the plurality of negative electrode tabs 221.

In an embodiment of the application, after the battery cell 20 is formed by the winding, in the first direction Z1, the orthographic projections of the plurality of positive electrode tabs 211 on the inner wall of the housing 10 overlap, and in the second direction Z2, the orthographic projections of the plurality of negative electrode tabs 221 on the inner wall of the housing 10 overlap.

The distance between two adjacent positive electrode tabs 211 or two adjacent negative electrode tabs 221 is the length of one circle of the positive electrode sheet 21 or the negative electrode sheet 22. It can be understood that the distance between the plurality of positive electrode tabs 211 arranged on one end face of the positive electrode sheet 21 gradually increases with the number of layers that the battery cell winds to form, so that, on the inner wall of the housing 10, the orthographic projections of the plurality of positive electrode tabs 211 arranged on the wound battery cell 20 can overlap; the distance between the plurality of negative electrode tabs 221 arranged on one end face of the negative electrode sheet 22 gradually increases with the number of layers that the battery cell winds to form, so that, on the inner wall of the housing 10, the orthographic projections of the plurality of negative electrode tabs 221 arranged on the wound battery cell 20 can overlap. Therefore, the injection and seepage of liquid is not blocked at both end faces of the battery cell, so that the qualified rate of producing the multi-tab battery is high and the battery cell product yield is high.

In an embodiment of the present application, the battery cell 20 includes a first end 20a and a second end 20b opposite to the first end 20a. The positive electrode tabs 211 are located at the first end 20a of the battery cell 20, and the negative electrode tabs 221 are located at the second end 20b of the battery cell 20.

The wound battery cell 20 is firstly ultrasonically pre-welded with the positive electrode tabs 211 and the negative electrode tabs 221 to fix the positive electrode tabs 211 and the negative electrode tabs 221.

In an embodiment of the application, the positive electrode tabs 211 and/or the negative electrode tabs 221 are perpendicular to the battery cell 20, and the lengths of the plurality of positive electrode tabs 211 in the extension direction of the battery cell 20 are same, and the lengths of the plurality of negative electrode tabs 221 in the extension direction of the battery cell 20 are same.

The first length may range from 15 mm to 17 mm, and the second length may range from 13 mm to 15 mm.

In an embodiment of the application, the positive electrode tabs 211 and/or the negative electrode tabs 221 are inclined relative to the battery cell 20, and the angle between the positive electrode tabs 211 and/or the negative electrode tabs 221 and the end face of the battery cell 20 is an acute angle.

When the angle between the positive electrode tabs 211 and/or the negative electrode tabs 221 and the end face of the battery cell 20 is an acute angle, the ends of the positive electrode tabs 211 away from the end face of the battery cell 20 are flush, and/or the ends of the negative electrode tabs 221 away from the end face of the battery cell 20 are flush. When the positive electrode tabs 211 and/or the negative electrode tabs 221 are inclined, the positive electrode tabs 211 and/or the negative electrode tabs 221 that are longer than the minimum length is pre-folded so that the ends of the positive electrode tabs 211 away from the end face of the battery cell 20 are flush, and/or the ends of the negative electrode tabs 221 away from the end face of the battery cell 20 are flush, which facilitates the welding.

The lengths of the folded positive electrode tabs 211 still satisfy the first length, and the lengths of the folded negative electrode tabs 221 still satisfy the second length. The first length may, for example, range from 15 mm to 17 mm, and the second length may, for example, range from 13 mm to 15 mm.

FIG. 4 is an exploded schematic diagram of a battery cell according to an embodiment of the present application.

Please refer to FIG. 4, in an embodiment of the present application, the battery cell 20 further includes an electrolyte. The electrolyte is disposed in the housing 10. The electrolyte is in the wound battery cell 20.

According to an embodiment of the present application, when the positive electrode tabs 211 and/or the negative electrode tabs 221 are arranged at unequal intervals after the winding, the injection of electrolyte is more convenient compared with batteries having tabs of other shapes. When the electrolyte is injected into the battery cell 20, it is in the gaps between the positive electrode sheet 21, the negative electrode sheet 22 and the separator 23, and flows in the housing 10 to form a current loop.

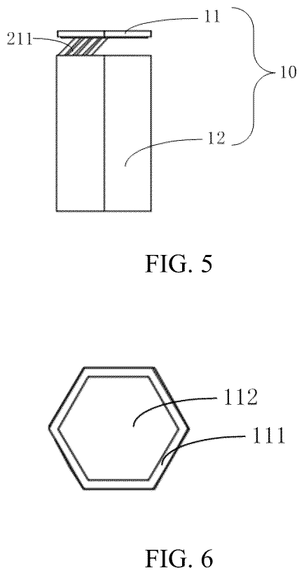

FIG. 5 is a further schematic diagram of the structure of a multi-tab battery according to an embodiment of the present application.

Please refer to FIG. 5, in an embodiment of the present application, the housing 10 of the multi-tab battery includes a cover 11 and a housing body 12. The battery cell 20 is arranged in the housing body 12. The positive electrode tags 211 are connected to the cover 11, and the negative electrode tabs 221 is connected to the end of the housing body 12 away from the cover 11.

The positive electrode tabs 211 are laser welded to the cover 11, and the negative electrode tabs 221 are resistance welded to the end of the housing body 12 away from the cover 11 by using a copper welding needle (the tip of which has a diameter of 1.5±0.1 mm).

In an embodiment of the present application, the battery cell 20 and the housing 10 are prismatic. The battery cell 20 is molded into a prism by a prismatic rolling pin fixture and a prismatic hot pressing fixture. The prismatic battery has strong plasticity and high volume utilization after being grouped, which is conducive to the small and light electrification of the battery system. However, the shape of the battery cell 20 and the housing 10 is not limited to prismatic, and can also be square, triangular or other polygonal shapes.

In an embodiment of the present application, the positive electrode tabs 211 are connected to the cover 11 at a preset angle, and the negative electrode tabs 221 are connected to an end of the housing body 12 away from the cover 11 at a preset angle.

The preset angle may be an acute angle. The positive electrode tabs 211 and the cover 11 are laser welded at a preset angle. The negative electrode tabs 221 and the end of the housing body 12 away from the cover 11 are resistance welded at a preset angle through a copper welding needle (the tip of which has a diameter of 1.5±0.1 mm).

The lengths of the folded positive electrode tabs 211 still satisfy the first length, and the lengths of the folded negative electrode tabs 221 still satisfy the second length. The first length may, for example, range from 15 mm to 17 mm, and the second length may, for example, range from 13 mm to 15 mm.

FIG. 6 is a schematic diagram of the structure of the cover according to an embodiment of the present application.

Please refer to FIG. 6, in an embodiment of the present application, the cover 11 includes an insulator 111 and a conductor 112. The positive electrode tabs 211 are connected to the conductor 112. The insulator 111 is disposed around the conductor 112.

The insulator 111 surrounds the outer circle of the conductor 112 by avoiding the welding area of the positive electrode tabs 211. The conductor 112 includes a first surface and a second surface opposite to the first surface. The first surface is laser welded to the positive electrode tabs 211, and the second surface is electrically connected to other batteries. The area of the insulator 111 also covers the orthographic projection of the wall of the housing body 12 on the cover 11.

After the electrode group rolling groove formation, short circuit test, baking and liquid injection are completed, the positive electrode tabs 211 is welded to the cover 11 by laser welding. The battery is made through sealing, cleaning, oiling, X-Ray radiation, and using film automatic assembly and packaging line. The battery is finally produced after aging, formation, OCV, capacity detection, and sorting processes.

An embodiment of the present application provides an electronic device, including the above-mentioned multi-tab battery, which is specifically applied to ultra-high rate devices.

In the multi-tab battery and device according to the present application, the battery cell 20 is formed by winding a separator 23, a positive electrode sheet 21 and a negative electrode sheet 22. A plurality of positive electrode tabs 211 and a plurality of negative electrode tabs 221 are welded at the respective end of the positive electrode sheet 21 and the negative electrode sheet 22. The plurality of positive electrode tabs 211 and the plurality of negative electrode tabs 221 are die-cut at unequal intervals. The plurality of positive electrode tabs 211 are arranged at intervals along the first direction Z1, and the plurality of negative electrode tabs 221 are arranged at intervals along the second direction Z2. The first direction Z1 intersects or overlaps with the second direction Z2. Therefore, the transmission path in the battery is short, the temperature and current density distribution during the charging and discharging process are more uniform, and the injection and seepage capacity are not affected. The battery cell 20 and the housing 10 are prismatic, which makes the battery have good mechanical load capacity and high group space utilization, which is conducive to the realization of product customization.

What is claimed is:

1. A multi-tab battery, comprising:
a housing; and
a battery cell, arranged in the housing;
wherein the battery cell comprises a separator, a positive electrode sheet, a negative electrode sheet, a plurality of positive electrode tabs and a plurality of negative electrode tabs;
wherein the separator is located between the positive electrode sheet and the negative electrode sheet; the plurality of positive electrode tabs are connected to the positive electrode sheet and are located at one end of the positive electrode sheet; the plurality of negative electrode tabs are connected to the negative electrode sheet and are located at one end of the negative electrode sheet; the battery cell is formed by winding the separator, the positive electrode sheet and the negative electrode sheet;
wherein the plurality of the positive electrode tabs are arranged at intervals along a first direction and protrude from the positive electrode sheet by a first length in an extension direction of the battery cell; the plurality of the negative electrode tabs are arranged at intervals along a second direction and protrude from the negative electrode sheet by a second length in the extension direction of the battery cell; the first length is greater than or same as the second length;
wherein the first direction and the second direction satisfy at least one of conditions:
the first direction intersecting with the second direction; and
the first direction overlapping with the second direction.

2. The multi-tab battery according to claim 1, wherein the first length ranges from 15 mm to 17 mm, and the second length ranges from 13 mm to 15 mm.

3. The multi-tab battery according to claim 2, wherein after the battery cell is formed by the winding, in the first direction, orthographic projections of the plurality of positive electrode tabs on an inner wall of the housing overlap, and in the second direction, orthographic projections of the plurality of negative electrode tabs on an inner wall of the housing overlap.

4. The multi-tab battery according to claim 1, wherein the plurality of positive electrode tabs have same lengths in the extension direction of the battery cell, and the plurality of negative electrode tabs have same lengths in the extension direction of the battery cell;
wherein the positive electrode tabs and the negative electrode tabs satisfy at least one of conditions:
the positive electrode tabs being perpendicular to the battery cell; and
the negative electrode tabs being perpendicular to the battery cell.

5. The multi-tab battery according to claim 1, wherein the positive electrode tabs and the negative electrode tabs satisfy at least one of conditions:
the positive electrode tabs being inclined relative to an end face of the battery cell at an acute angle; and
the negative electrode tabs being inclined relative to an end face of the battery cell at an acute angle.

6. The multi-tab battery according to claim 1, wherein the battery cell further comprises:
an electrolyte, disposed in the housing;
wherein the electrolyte is in the battery cell formed by the winding.

7. The multi-tab battery according to claim 1, wherein the housing comprises a cover and a housing body where the battery cell is arranged, wherein the positive electrode tabs are connected to the cover, and the negative electrode tabs are connected to an end of the housing body away from the cover.

8. The multi-tab battery according to claim 7, wherein the battery cell formed by the winding and the housing are prismatic.

9. The multi-tab battery according to claim 7, wherein the positive electrode tabs are connected to the cover at a preset angle, and the negative electrode tabs are connected to the end of the housing body away from the cover at a preset angle.

10. The multi-tab battery according to claim 7, wherein the cover comprises an insulator and a conductor, wherein the positive electrode tabs are connected to the conductor, and the insulator is arranged around the conductor.

11. An electronic device, comprising a multi-tab battery comprising:
a housing; and
a battery cell, arranged in the housing;
wherein the battery cell comprises a separator, a positive electrode sheet, a negative electrode sheet, a plurality of positive electrode tabs and a plurality of negative electrode tabs;
wherein the separator is located between the positive electrode sheet and the negative electrode sheet; the plurality of positive electrode tabs are connected to the positive electrode sheet and are located at one end of the positive electrode sheet; the plurality of negative electrode tabs are connected to the negative electrode sheet and are located at one end of the negative electrode sheet; the battery cell is formed by winding the separator, the positive electrode sheet and the negative electrode sheet;
wherein the plurality of the positive electrode tabs are arranged at intervals along a first direction and protrude from the positive electrode sheet by a first length in an extension direction of the battery cell; the plurality of the negative electrode tabs are arranged at intervals along a second direction and protrude from the negative electrode sheet by a second length in the extension direction of the battery cell; the first length is greater than or same as the second length;
wherein the first direction and the second direction satisfy at least one of conditions:
the first direction intersecting with the second direction; and
the first direction overlapping with the second direction.

12. The electronic device according to claim 11, wherein the first length ranges from 15 mm to 17 mm, and the second length ranges from 13 mm to 15 mm.

13. The electronic device according to claim 12, wherein after the battery cell is formed by the winding, in the first direction, orthographic projections of the plurality of positive electrode tabs on an inner wall of the housing overlap, and in the second direction, orthographic projections of the plurality of negative electrode tabs on an inner wall of the housing overlap.

14. The electronic device according to claim 11, wherein the plurality of positive electrode tabs have same lengths in the extension direction of the battery cell, and the plurality of negative electrode tabs have same lengths in the extension direction of the battery cell;
wherein the positive electrode tabs and the negative electrode tabs satisfy at least one of conditions:
the positive electrode tabs being perpendicular to the battery cell; and
the negative electrode tabs being perpendicular to the battery cell.

15. The electronic device according to claim 11, wherein the positive electrode tabs and the negative electrode tabs satisfy at least one of conditions:
the positive electrode tabs being inclined relative to an end face of the battery cell at an acute angle; and
the negative electrode tabs being inclined relative to an end face of the battery cell at an acute angle.

16. The electronic device according to claim 11, wherein the battery cell further comprises:
an electrolyte, disposed in the housing;
wherein the electrolyte is in the battery cell formed by the winding.

17. The electronic device according to claim 11, wherein the housing comprises a cover and a housing body where the battery cell is arranged, wherein the positive electrode tabs are connected to the cover, and the negative electrode tabs are connected to an end of the housing body away from the cover.

18. The electronic device according to claim 17, wherein the battery cell formed by the winding and the housing are prismatic.

19. The electronic device according to claim 17, wherein the positive electrode tabs are connected to the cover at a preset angle, and the negative electrode tabs are connected to the end of the housing body away from the cover at a preset angle.

20. The electronic device according to claim 17, wherein the cover comprises an insulator and a conductor, wherein the positive electrode tabs are connected to the conductor, and the insulator is arranged around the conductor.
